(19) United States
(12) Patent Application Publication
(10) Pub. No.: US 2026/0131277 A1
(43) Pub. Date: May 14, 2026

(54) AN AIR TREATMENT SYSTEM FOR PROVIDING TREATED AIR IN A DEFINED SPACE, A METHOD FOR CONTROLLING AN AIR TREATMENT SYSTEM AND A COMPUTER PROGRAM FOR AN AIR TREATMENT SYSTEM

(71) Applicant: MUNTERS EUROPE AKTIEBOLAG, Kista (SE)

(72) Inventors: Robert Arnell, Orsundsbro (SE); Lena Allzen, Jarfalla (SE); Max Pantzar, Alvsjo (SE); Anders Granstrand, Taby (SE)

(21) Appl. No.: 19/118,646

(22) PCT Filed: Oct. 3, 2023
(86) PCT No.: PCT/EP2023/077307

§ 371 Date: Apr. 4, 2025

(30) Foreign Application Priority Data
Oct. 6, 2022 (SE) 2251162-0

(51) Int. Cl. B01D 53/06; F24F 3/16

(52) U.S. Cl. CPC B01D 53/06; F24F 3/16; B01D 2257/708; B01D 2258/06; B01D 2259/4009; B01D 2259/4508; F24F 2203/106

(57) ABSTRACT

The disclosure relates to an air treatment system (100) for providing treated air in a defined space (S) comprising a gas sorption device (10) with a gas sorption rotor (1); a process air circuit (2) arranged to conduct a process air flow through a process section (3) of the gas sorption rotor (1); a regeneration air circuit (4) arranged to conduct a regeneration air flow through a regeneration section (5) of the gas sorption rotor (1); and a control device (6) configured to determine that predetermined starting criteria are fulfilled; and control, in a cleaning mode, a flow of outdoor air (OA) to circumvent the process section (3) of the gas sorption rotor (1), and pass through the regeneration section (5) of the gas sorption rotor (1) before being exhausted. The disclosure further relates to a method for controlling an air treatment system (100) and a computer program for an air treatment system (100).

### TECHNICAL FIELD

The present disclosure relates to an air treatment system for providing treated air in a defined space, a method for controlling an air treatment system and a computer program for an air treatment system as defined in the introductory parts of the independent claims.

### BACKGROUND ART

Air treatment systems of various kinds are commonly used for providing treated air into a defined space. Such air treatment systems comprising some sort of gas sorption device with a gas sorption element might sometimes cause unwanted odors, for example due to contaminations with a higher boiling point than water being accumulated in the sorption element. The smell might appear when the air treatment system is started for the day, after having been shut down. The fresh air may then displace the smelly contaminations accumulated in the sorption element, such that the smelly contaminations are introduced into the defined space together with the treated air. This could be perceived as unpleasant for the persons present in the defined space. How the air treatment system is operated may also affect the presence of odor. For example, if regeneration/reactivation of the sorption element is not performed regularly or if it is performed at low temperatures, there is a greater risk that contamination will accumulate and cause odors.

The problem of odors is known and there exist a couple of different solutions to this problem. For example, carbon filters may be used to collect the smelly contaminations and replacing such filter regularly might reduce the risk of odors. However, such carbon filters are not very effective in humid environments since they easily are clogged. Another solution, shown in JP2005058937 A, is to perform regeneration at high temperatures prior to each start up. This is a very effective way to remove the contaminations but it will inevitably result in a higher energy use. Replacing the sorption element or even the gas sorption device frequently could also solve the problem but that is of course both costly and time consuming. Another solution is to regenerate and dry the sorption element with the use of outdoor/outside air or indoor air prior to each startup of the air treatment system. Such solutions are typically not very energy efficient.

KR20180136378 A describes a system where a cleaning mode is used to purify the rotor to avoid unpleasant odors. In KR20180136378, the cleaning mode is initiated based on measured VOC levels in the rotor and uses heated outdoor air. The cleaning mode may also be initiated based on a timer setting.

### SUMMARY

It is an object of the present disclosure to mitigate, alleviate or eliminate one or more of the above-identified deficiencies and disadvantages in the prior art and solve at least the above-mentioned problems.

Another object of the present disclosure is to achieve an air treatment system and a method for controlling such air treatment system, which will handle smelly contaminations in the environment of the air treatment system in an effective way and thereby minimize the risk for unpleasant smell/odors entering a defined space.

According to a first aspect of the present disclosure, there is provided an air treatment system for providing treated air in a defined space, the system comprising a gas sorption device with a gas sorption rotor; a process air circuit arranged to conduct a process air flow through a process section of the gas sorption rotor; a regeneration air circuit arranged to conduct a regeneration air flow through a regeneration section of the gas sorption rotor; and a control device configured to determine that at least one predetermined starting criterion is fulfilled; and control, in a cleaning mode, a flow of outdoor air to circumvent the process section of the gas sorption rotor, and pass through the regeneration section of the gas sorption rotor before being exhausted. The control device is thus configured to start/perform the cleaning mode when the at least one starting criterion is fulfilled. The at least one starting criterion concerns at least one attribute of the outdoor air, or at least one attribute of the air in the defined space (S).

Outdoor air may also be referred to as outside air. The intended meaning herein is that outdoor air is air that flows into the system from an air intake located outdoors, i.e. outside of a building in which air treatment is performed. In addition, outdoor air may be referred to as atmospheric air or fresh air. The outdoor air is preferably untreated air, although some filtration may be used to avoid letting polluting particles into the air treatment system.

Attributes of the outdoor air may be attributes, or properties, of the air, such as humidity, temperature and/or pollution levels. Attributes of the air in the defined space, which is indoor air, may be pollution levels such as VOC levels.

By actively initiating a cleaning mode where outdoor air is passing through the regeneration section of the gas sorption rotor, only when certain starting criteria are fulfilled, the gas sorption element can be cleaned in an efficient and energy saving way and the risk for odors during normal operation of the air treatment system is reduced. Using outdoor air is advantageous since it naturally is humid and a certain level of humidity will improve the cleaning of the gas sorption rotor. The outdoor air will in the cleaning mode circumvent the process section of the gas sorption rotor and thereby maintain its natural humidity. The outdoor air will pass through the regeneration section of the gas sorption rotor and displace the accumulated smelly contaminations and then the air, containing the smelly contaminations, will be discharged/exhausted to the outside. This way, the smelly contamination will not flow into the defined space when the air treatment system is used for normal operation.

The gas sorption device may be a dehumidifier, for example a desiccant dehumidifier, a VOC adsorber or a CO2 adsorber. The gas sorption rotor may be a desiccant rotor, a rotating horizontal bed a VOC adsorbing rotor, a CO2 adsorbing rotor or similar. It is to be understood that even though some specific components/devices/elements of the air treatment system are disclosed herein, the air treatment system may comprise more components/devices/elements that are considered to be commonly known within the technical field of air treatment systems.

In one example, the air treatment system comprises a first fan arranged in the regeneration air circuit, downstream of the gas sorption rotor. The first fan may be arranged to draw regeneration air through the regeneration section of the gas sorption rotor during normal operation of the air treatment system. The control device may be configured to, in the cleaning mode, control the first fan to draw outdoor air into the air treatment system and to pass through the regeneration section of the gas sorption rotor.

The air treatment system may comprise a first damper arranged between the process air circuit and the defined space. The first damper is typically closed during the cleaning mode, such that it ensured that no air is provided from the air treatment system into the defined space during the cleaning mode. This way is ensured that smelly contaminations are not introduced into the defined space. The air treatment system may also comprise a second damper arranged between the regeneration air circuit and the defined space. The second damper is typically closed during the cleaning mode, such that it is ensured that no air from the defined space is entering the air treatment system during the cleaning mode and thereby affect the regeneration of the gas sorption rotor negatively. Controlling the flow of outdoor air to circumvent the process section of the gas sorption rotor and pass through the regeneration section of the gas sorption rotor may thus comprise closing the first damper and/or the second damper.

In one example of the present disclosure, the at least one starting criterion comprises that the humidity of the outdoor air is above a predefined lower threshold level. In such an example, the starting criterion thus relates to humidity as the at least one attribute of the outdoor air. The predefined lower threshold level may relate to the relative humidity of the outdoor air. In that case, the predefined lower threshold level may be 40%, preferably 50% or more preferably 60%. Alternatively, the at least one starting criterion relating to humidity relates to the absolute humidity of the outdoor air. In that case, the predefined lower threshold level may be 3 g/kg, preferably 4 g/kg or more preferably 5 g/kg. By making sure that the cleaning mode only is performed when the outdoor air has a predefined humidity, it is ensured that the gas sorption rotor is efficiently cleaned. Also, with an outdoor air having at least a predefined lowest humidity, the cleaning mode can be performed during a shorter time period, which in turn leads to less down time of the air treatment system.

As an example, the at least one starting criterion comprises that the outdoor air has a temperature within a predefined temperature range. In such an example, the starting criterion thus relates to temperature as the at least one attribute of the outdoor air. If the outdoor air used for the cleaning mode is too cold, there is a risk that the gas sorption rotor will freeze during cleaning mode, which is not advantageous. Also, if the temperature of the outdoor air is too high, the humidity might be too low to efficiently clean the gas sorption rotor. The predefined temperature range may be between 5-18 degrees Celsius. Relative humidity depends on the current temperature of the air, whereas absolute humidity is the actual amount of water vapor present in the air, regardless of the temperature. Relative humidity can be described as measuring the moisture contained in the air relative to the maximum value at the dry bulb temperature of the air sample. The value of relative humidity does not specify the moisture content of the air unless accompanied by the temperature of the air. Thus, in the event that the starting criteria comprises that the outdoor air must have a relative humidity above a predefined lowest threshold level, the starting criteria may also comprise that the outdoor air has a temperature within a predefined temperature range. If the moisture content in the air remains constant, the relative humidity decreases as the temperature increases and vice-versa.

According to some examples, the at least one starting criterion comprises that a measured VOC (Volatile Organic Compound) level in the defined space is above a predetermined VOC level and/or that a measured odor level in the defined space is above a predetermined odor level. In such an example, the starting criterion thus relates to VOC and/or odor levels as the at least one attribute of the air in the defined space. The air in the defined space is generally indoor air. The air treatment system may thus comprise a VOC and/or odor sensor arranged in the defined space, in communication with the control device. Alternatively, the control device of the air treatment system may be arranged in communication with an external VOC and/or odor sensor inside the defined space. When the VOC/odor sensor registers a VOC/odor level above the predetermined level it may indicate that a cleaning mode could be advantageous to avoid increasing the level further inside the defined space. Typically, the control device of the air treatment system continually receives information (VOC/odor level) from the VOC/odor sensor and determines when the level is above the predetermined VOC/odor level. When the current VOC/odor level is above the predetermined VOC/odor level, the control device may initiate the cleaning mode the next time the air treatment system is shut down. Typically, it is not advantageous to stop normal operation of the air treatment system and perform the cleaning mode when normal operation is expected. It is thus better to wait for the next scheduled down time and then perform the cleaning mode. The control device may additionally or alternatively be configured to perform the cleaning mode during a longer time period at the next scheduled down time of the air treatment system, after having determined that the VOC/odor level from the VOC/odor sensor is above the predetermined VOC/odor level. The predetermined VOC level may depend on which volatile organic compound is relevant to use as a starting criteria for starting the cleaning mode. Typically, the predetermined VOC level is set to a ppm level where the relevant volatile organic compound normally causes an odor.

According to one example, the at least one starting criterion additionally comprises a predetermined time parameter, such that the cleaning mode is initiated at a predetermined time of the day or and/or day of the week and/or month of the year, providing that at least one of the previously determined starting criteria has been met. When, during the day, the cleaning mode should be performed may of course affect the normal operation of the air treatment system but the time of the day could also have implications on the outdoor air. For example, the humidity of the outdoor air is normally higher early in the morning. Also, the outdoor air is more humid during the summer than during winter. The time parameter may comprise that the cleaning mode should be initiated after office hours. Alternatively, the time parameter comprises that the cleaning mode should be initiated during the night after normal operation of the air treatment system, or early in the morning just before normal operation of the air treatment system. The time parameter may comprise that the cleaning mode should be performed only at certain days of the week, once a week, once a month, only during summer months or similar.

It is to be understood that any combination of starting criteria mentioned herein is possible. This does not mean that all criteria must be fulfilled at the same time, but that at least one of the criteria must be fulfilled in order for the control device to start the cleaning mode. As an example, the starting criteria comprises that the cleaning mode should be initiated early in the morning on Tuesdays and Thursdays or that a measured VOC level in the defined space is above a predetermined VOC level and/or that a measured odour level is above a predetermined odour level. Thus, should the control device determine that the measured VOC level in the defined space is above the predetermined VOC level on a Tuesday afternoon, the control device may be configured to perform the cleaning mode as the system is shut down on Tuesday evening or just before starting the system on Wednesday, even though the next scheduled cleaning mode should be early in the morning on Thursday according to the time parameter starting criterion.

According to an example of the present disclosure, the at least one starting criterion comprises manual input requesting cleaning mode. The air treatment system may comprise a maneuvering element, such as a button, lever or switch, which when manually operated by an operator indicates that the operator wants to start the cleaning mode. The control device may thus be arranged in communication with the maneuvering element and be configured to determine if the maneuvering element has been operated or not. Thus, the cleaning mode can be started by an operator manually pushing a button or similar. Similarly, the air treatment system may comprise a maneuvering element, such as a button, lever or switch, which when manually operated by an operator indicates that the operator wants to terminate the cleaning mode. By having the possibility to manually activate the cleaning mode, an operator can judge by himself/herself if cleaning mode is required or not and control the air treatment system accordingly. A safe, robust and flexible air treatment system is thereby achieved.

According to another example, the air treatment system comprises a cleaning conduit fluidly connected to the outdoor air and the regeneration air circuit upstream of the gas sorption rotor, wherein the control device is configured to control the flow of outdoor air to enter via the cleaning conduit. By means of the separate cleaning circuit, the outdoor air is communicating with the regeneration air circuit via the cleaning conduit, and the process section of the gas sorption rotor is circumvented. Thus, the outdoor air used for the cleaning mode does not have to pass through the process air circuit, which is the case during normal operation of the air treatment system. With a separate cleaning conduit for the cleaning mode outdoor air, the rest of the system does not have to be adapted to the cleaning mode functionality. The cleaning conduit is suitably only used for the cleaning mode, and is typically not used during normal operation of the air treatment system. The air treatment system may further comprise a first valve arranged in the cleaning conduit to regulate the flow of air between the cleaning conduit and the regeneration air circuit. Thus, the control device may be configured to control the first valve to open in the cleaning mode, to control the flow of outdoor air passing via the cleaning conduit.

According to one example, the air treatment system comprises at least one circulation damper connecting the process air circuit and the regeneration air circuit upstream of the regeneration section of the gas sorption rotor, wherein the control device is configured to control the flow of outdoor air to pass from the process air circuit via the circulation damper to the regeneration air circuit. The control device may also be configured to control the first fan to draw outdoor air through the process air circuit, via the circulation damper to the regeneration air circuit and through the regeneration section of the gas sorption rotor. The at least one circulation damper may be arranged downstream of the process section of the gas sorption rotor. To circumvent the process section of the gas sorption rotor, the air treatment system may comprise a bypass circuit fluidly connected to the process air circuit. The bypass circuit may be arranged to allow process air to bypass the process section of the gas sorption rotor during normal operation of the air treatment system. This can be advantageous in the event that the outdoor air (process air) entering the process air circuit do not have to be dried and therefore do not have to pass through the process section of the gas sorption rotor. In order to enable the process air to bypass the process section of the gas sorption rotor, the air treatment system may further comprise a second valve arranged in the bypass circuit. In the cleaning mode, the control device may be configured to control the second valve to open to allow outdoor air to circumvent the process section of the gas sorption rotor via the bypass conduit. The control device may also be configured to control the at least one circulation damper to open to allow the outdoor air to flow to the regeneration air circuit and through the regeneration section of the gas sorption rotor.

According to one example of the present disclosure, the air treatment system comprises an evaporative humidifier arranged in the regeneration air circuit, wherein the control device is configured to control the flow of outdoor air to pass via the evaporative humidifier before passing through the regeneration section of the gas sorption rotor. The evaporative humidifier is thus arranged upstream of the regeneration section of the gas sorption rotor. By allowing the outdoor air to pass through an evaporative humidifier during the cleaning mode, the air flowing through the regeneration section of the gas sorption rotor will have a higher humidity and the cleaning will be improved. The control device may be configured to control the flow of outdoor air to pass through the humidifier during cleaning mode, when the humidity of the outdoor air is within a predetermined range. For example, the at least one starting criterion may comprise that the humidity of the outdoor air is above 40% but if the humidity is between 40-55% the control device may be configured to control the air to pass through the evaporative humidifier before passing through the regeneration section of the gas sorption rotor. The relative humidity of the outdoor air passing through the regeneration section of the gas sorption rotor is preferably at least 60%. Thus, if the outdoor air is below 60% but the air treatment system comprises the evaporative humidifier, the cleaning mode may be initiated anyway and the air will be controlled to flow through the humidifier first. As another example, the control device may have determined that the current VOC level in the defined space is above the predetermined VOC level. In such case, the control device may be configured to control the air to flow through the humidifier the next time the cleaning mode is scheduled, even if the humidity of the outdoor air is 60%, to boost the humidity and thereby improve the cleaning of the gas sorption rotor. The control device may be configured to always or periodically control the flow of outdoor air to pass via the evaporative humidifier before passing through the regeneration section of the gas sorption rotor, or the control device may be configured to control the flow of outdoor air to pass via the evaporative humidifier before passing through the regeneration section of the gas sorption rotor, based on the humidity/temperature of the incoming outdoor air or the current VOC/odor level in the defined space. It is to be understood that the evaporative humidifier may form part of the regeneration air circuit and be used also during normal operation of the air treatment system.

In the event that the air treatment system comprises the cleaning conduit, the cleaning conduit may be connected to the regeneration air circuit upstream of the evaporative humidifier. The cleaning conduit may also be connected to the regeneration air circuit downstream of the evaporative humidifier. This way, outdoor air can be controlled to flow through the evaporative humidifier or not. In the event that the cleaning mode involves outdoor air to enter via the process air circuit, the at least one circulation damper may be arranged to connect the process air circuit and the regeneration air circuit upstream of the evaporative humidifier. The air treatment system may comprise a first circulation damper connecting the process air circuit and the regeneration air circuit downstream of the evaporative humidifier, and a second circulation damper arranged to connect the process air circuit with the regeneration air circuit upstream of the evaporative humidifier. This way, the outdoor air can controlled to pass through the evaporative humidifier or not.

According to an example, the air treatment system further comprises a heater device, wherein the control device is configured to control the flow of outdoor air to pass via the heater device before passing through the regeneration section of the gas sorption rotor. The heater device may be arranged upstream of the evaporative humidifier. With a heater device, the air treatment system may be configured, such that the outdoor air for cleaning mode is entering the regeneration air circuit upstream of the heater device. Increasing the temperature of the outdoor air could reduce the humidity, therefore the heater device should be arranged upstream of the evaporative humidifier. By having a heater device, the cleaning mode can be performed also when the outdoor air is too cold to directly pass through the gas sorption rotor. The combination of a heater device and an evaporative humidifier may thus enable use of the cleaning mode during winter months or when the weather conditions are too poor to use the outdoor air untreated for cleaning mode.

According to an example of the present disclosure, the control device is configured to terminate the cleaning mode when at least one predetermined termination criterion is fulfilled, wherein the at least one predetermined termination criterion comprises that a predetermined time has lapsed after initiation of the cleaning mode and/or that the VOC level of the air downstream of the regeneration section of the gas sorption rotor is below a predetermined termination VOC level. The control device may thus be configured to terminate the cleaning mode after a predetermined cleaning time, for example after 20-60 minutes. The predetermined cleaning time is suitably the time it takes to achieve a sufficient/desired cleaning of the regeneration section. The predetermined cleaning time may depend on various factors, For example, the cleaning time may depend on the airflow through the regeneration section of the gas sorption rotor. The airflow through the regeneration section can be regulated by controlling the first fan and/or the second fan. A higher airflow through the regeneration section may speed up the cleaning process and the cleaning mode can be terminated after a shorter period of time. The control device may thus be configured to control the first and/or second fan to achieve a desired flow through the regeneration section during the cleaning mode and that way achieve a desired cleaning time. Furthermore, the predetermined cleaning time may depend on the humidity of the outdoor air. The humidity of the outdoor air may vary during the day and the cleaning time can thus differ depending on the time of the day when the cleaning mode is performed. Similarly, the humidity of the outdoor air may vary depending on the season and the cleaning time can thus differ depending on the day of the year the cleaning mode is performed. Also, the humidity of the outdoor air can be affected by controlling the flow of outdoor air through the evaporative humidifier. The control device may thus be configured to control the flow of outdoor air through the evaporative humidifier to achieve a desired humidity and that way achieve a desired cleaning time. The predetermined cleaning time may also depend on the size/area of the regeneration section since that will affect the nominal flow through the regeneration section. In some embodiments, the gas sorption device comprises a gas sorption rotor with a variable regeneration section. The gas sorption rotor may thus comprise a regeneration section, which can vary in size. This can be achieved by using a device, which can be folded, extended or displaced to cover a larger or smaller area of the gas sorption rotor, and thereby affect the area of the regeneration section. By controlling the size of the regeneration section, the cleaning time can be affected. The control device may thus be configured to control the area/size of the regeneration section to achieve a desired flow through the regeneration section during the cleaning mode and that way achieve a desired cleaning time. The predetermined cleaning time may alternatively or additionally depend on the rotational speed of the gas sorption rotor. The control device may thus be configured to control the rotational speed of the gas sorption rotor and that way achieve a desired cleaning time.

Alternatively or additionally, the control device may be configured to terminate the cleaning mode when the air having cleaned the regeneration section of the gas sorption rotor has a sufficiently low VOC level. When the cleaning mode is initiated, the air cleaning the regeneration section will displace a lot of contaminations and the air downstream of the regeneration section will thus have a relatively high level of VOC when being discharged/exhausted to the outside. After some time, as the regeneration section is cleaned and the amount of contaminations in the regeneration section is reduced, the VOC level in the air downstream of the gas sorption rotor will have a lower VOC level. Thus, when the VOC level in the air downstream of the regeneration section of the gas sorption rotor is below the predetermined termination level, the regeneration section of the gas sorption rotor is considered to be sufficiently clean and the cleaning mode can be terminated. The predetermined termination VOC level may depend on which volatile organic compound is used as a termination criterion for ending the cleaning mode. Typically, the predetermined termination VOC level is set to a ppm level below the level where the relevant volatile organic compound normally causes an odor.

According to the first aspect of the present disclosure, there is also provided a method for controlling an air treatment system as disclosed herein, wherein the method comprises determining that at least one predetermined starting criterion is fulfilled; and controlling, in a cleaning mode, a flow of outdoor air to circumvent the process section of the gas sorption rotor and pass through the regeneration section of the gas sorption rotor before being exhausted. The method thus comprises to start/perform a cleaning mode when at least one predetermined starting criterion has been fulfilled. The method is preferably a computer-implemented method performed by means of the control device described herein.

It is to be understood that all the features and advantages described with regard to the air treatment system are also applicable for the method.

The step of controlling the flow of outdoor air to pass through the regeneration section of the gas sorption rotor may comprise controlling the flow of outdoor air to enter via a cleaning conduit fluidly connected to the outdoor air and the regeneration air circuit upstream of the gas sorption rotor.

According to one example, the step of controlling the flow of outdoor air to pass through the regeneration section of the gas sorption rotor comprises controlling the flow of outdoor air to pass from the process air circuit via a circulation damper to the regeneration air circuit. The outdoor air thus enters via the process air circuit, passes via a circulation damper to the regeneration air circuit and then passes through the regeneration section of the gas sorption rotor.

The method may further comprise controlling the flow of outdoor air to pass via an evaporative humidifier arranged in the regeneration air circuit, before passing through the regeneration section of the gas sorption rotor. This way, the humidity of the outdoor air can be increased and the cleaning of the regeneration section of the gas sorption rotor can be improved.

The method may further comprise controlling the flow of outdoor air to pass via a heater device arranged in the regeneration air circuit, before passing through the regeneration section of the gas sorption rotor. This way, the temperature of the outdoor air can be increased and the cleaning of the regeneration section of the gas sorption rotor can be improved.

The method may further comprise terminating the cleaning mode when at least one predetermined termination criterion is fulfilled, wherein the at least one predetermined termination criterion comprises that a predetermined cleaning time has lapsed after initiation of the cleaning mode and/or that the VOC level of the air downstream of the regeneration section of the gas sorption rotor is below a predetermined termination VOC level.

According to the first aspect of the present disclosure, a computer program for an air treatment system is also provided. The air treatment system comprises a gas sorption device with a gas sorption rotor; a process air circuit arranged to conduct a process air flow through a process section of the gas sorption rotor; a regeneration air circuit arranged to conduct a regeneration air flow through a regeneration section of the gas sorption rotor; and a control device comprising at least one processor, the computer program comprising computer-readable Instructions which, when executed by the at least one processor, causes the air treatment system to carry out the steps of the method as disclosed herein.

Furthermore, according the first aspect of the present disclosure there is provided a computer program product comprising at least one computer-readable medium, such as a non-transitory memory, storing the above mentioned computer program.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure will be more fully appreciated by reference to the following illustrative and non-limiting detailed description of example embodiments of the present disclosure, when taken in conjunction with the accompanying drawings.

FIG. 1a schematically illustrates an air treatment system according to an example of the present disclosure;

FIG. 1b schematically illustrates a control device according to an example of the present disclosure;

FIG. 2 schematically illustrates an air treatment system according to an example of the present disclosure;

FIG. 3 schematically illustrates an air treatment system according to an example of the present disclosure;

FIG. 4 schematically illustrates an air treatment system according to an example of the present disclosure;

FIG. 5 schematically illustrates an air treatment system according to an example of the present disclosure; and

FIG. 6 illustrates a diagram of a method for controlling an air treatment system according to an example of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

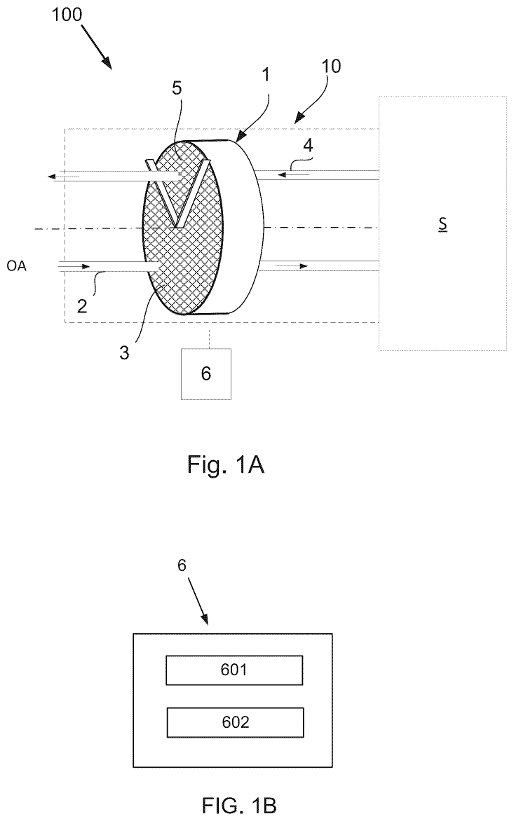

FIG. 1a schematically illustrates an air treatment system 100 for providing treated air in a defined space S according to an example of the present disclosure. The air treatment system 100 comprises a gas sorption device 10 with a gas sorption rotor 1; a process air circuit 2 arranged to conduct a process air flow through a process section 3 of the gas sorption rotor 1; and a regeneration air circuit 4 arranged to conduct a regeneration air flow through a regeneration section 5 of the gas sorption rotor 1. During normal operation of the air treatment system 100, outdoor air OA (process air) is typically entering the process air circuit and passes through the process section 3 of the gas sorption rotor 1 in order to dry the outdoor air. The dried air is then provided to the defined space S. Indoor air from the defined space S may be used as regeneration air in the regeneration air circuit 4, for regeneration of the regeneration section 5 of the gas sorption rotor 1. The regeneration air having passed the regeneration section 5 of the gas sorption rotor 1 is then exhausted. It is to be understood that the air treatment system 100 may comprise other devices for treating the air before being provided to the defined space S, or for treating the regeneration air, even though they are not disclosed in this this figure. The flow direction of the air during normal operation of the air treatment system 100 is illustrated with arrows in the circuits 2, 4. This type of air treatment system 100 is considered to be commonly known and we will not explain in further detail how such air treatment system 100 works during normal operation.

The air treatment system 100 according to the present disclosure also comprises a control device 6 configured to determine that at least one predetermined starting criterion is fulfilled; and control, in a cleaning mode, a flow of outdoor air OA to circumvent the process section 3 of the gas sorption rotor 1, and pass through the regeneration section 5 of the gas sorption rotor 1 before being exhausted. Thus, the cleaning mode includes creating a flow of outdoor air OA circumventing the process section 3 of the gas sorption rotor 1, and passing through the regeneration section 5 of the gas sorption rotor 1 to cleaning the regeneration section 5. The cleaning mode is not performed during normal operation of the air treatment system 100.

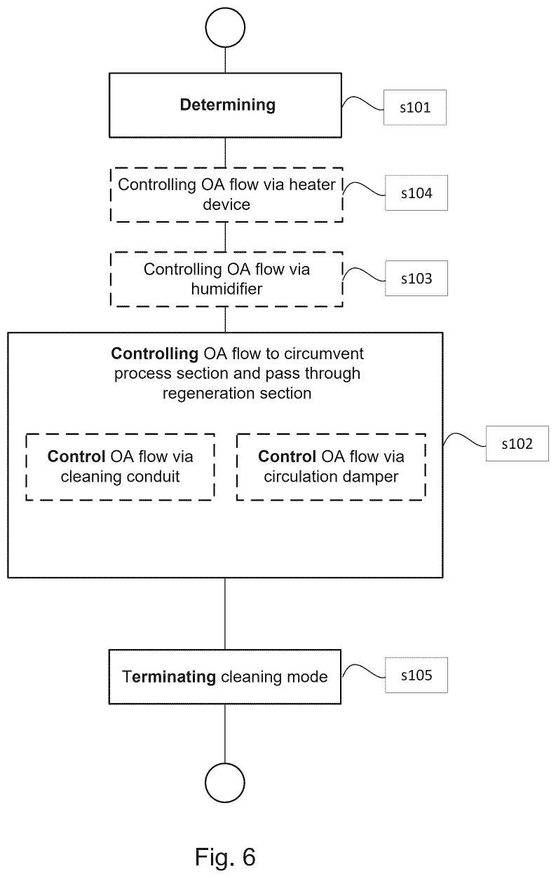

FIG. 1b illustrates an exemplary embodiment of a control device 6 of an air treatment system 100 according to the present disclosure. The control device 6 may form part of an air treatment system 100 as disclosed in FIG. 1a. The control device 6 comprises at least one processor 601 and a storage medium 602. The control device 6 may be configured to perform the method as described in FIG. 6 upon execution of a computer program by the at least one processor 601. The computer program(s) comprise computer-readable instructions that may be stored in the storage medium 602, such as a non-transitory hardware memory device of the control device 6.

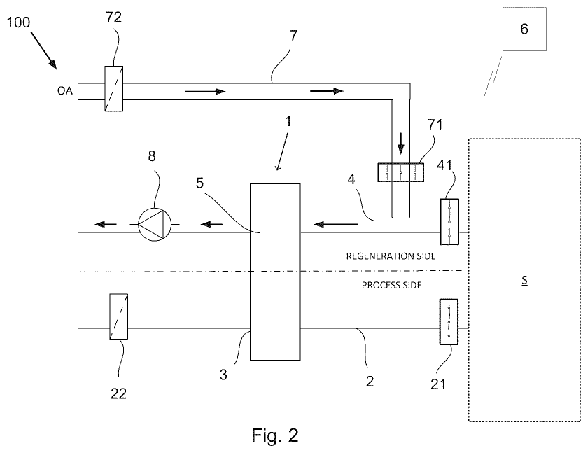

FIG. 2 schematically illustrates an air treatment system 100 for providing treated air in a defined space S according to an example of the present disclosure. The air treatment system 100 may be configured as disclosed in FIG. 1a. In this example, the air treatment system 100 comprises a cleaning conduit 7 fluidly connected to the outdoor air OA and the regeneration air circuit 4 upstream of the gas sorption rotor 1. The cleaning conduit 7 may comprise a first end with a first opening facing the outside. The cleaning conduit 7 may further comprise a second end with a second opening connected to the regeneration air circuit 4. The air treatment system 1 further comprises a first valve 71 arranged in the cleaning conduit 7 to regulate the flow of air between the cleaning conduit 7 and the regeneration air circuit 4. When the first valve 71 is open, the cleaning conduit 7 is in fluid communication with the regeneration air circuit 4, and when the first valve 71 is closed, the cleaning conduit 7 is not in fluid communication with the regeneration air circuit 4.

The air treatment system 100 comprises a first fan 8 arranged in the regeneration air circuit 4, downstream of the gas sorption rotor 1. The first fan 8 is arranged to draw regeneration air through the regeneration section 5 of the gas sorption rotor 1 during normal operation of the air treatment system 100.

The air treatment system 100 also comprises a first damper 21 arranged between the process air circuit 2 and the defined space S. The first damper 21 may be closed during the cleaning mode, such that it ensured that no air is provided from the air treatment system 100 into the defined space S during the cleaning mode. The air treatment system 100 also comprises a second damper 41 arranged between the regeneration air circuit 4 and the defined space S. The second damper 41 may be closed during the cleaning mode, such that it is ensured that no air from the defined space S is entering the air treatment system 100 during the cleaning mode.

The air treatment system 100 optionally comprises a first filter unit 22 arranged at the inlet of the process air circuit 2. The first filter unit 22 is arranged to filter the incoming outdoor air and thereby prevent too contaminated air to enter the gas sorption rotor 1. A second filter unit 72 may be arranged at the inlet of the cleaning conduit 7 to filter the outdoor air OA entering the cleaning conduit 7.

The control device 6 is arranged in communication with the first fan 8, the first valve 71, the first damper 21 and the second damper 41.

During cleaning mode, when at least one starting criterion is fulfilled, the control device 6 may be configured to close the first damper 21 and/or the second damper 42. The control device 6 is configured to, in the cleaning mode, control the first fan 8 to draw outdoor air to pass through the regeneration section 5 of the gas sorption rotor 1. Typically, the control device 6 is configured to control the first fan 8 to draw outdoor air OA through the cleaning conduit 7 to the regeneration air circuit 4 and through the regeneration section 5 of the gas sorption rotor 1. Thus, the control device 6 may be configured to control the first valve 71 to open in the cleaning mode, to enable a flow of outdoor air OA passing via the cleaning conduit 7 to the regeneration air circuit 4. The figure shows the air treatment system 100 in the cleaning mode, where first valve 71 is open and the first and second dampers 21, 41 are closed. The flow of outdoor air OA cleaning the regeneration section 5 of the gas sorption rotor 1 is illustrated with arrows.

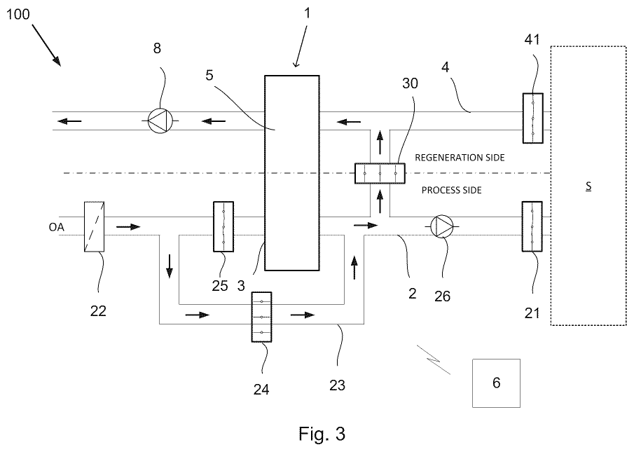

FIG. 3 schematically illustrates an air treatment system 100 for providing treated air in a defined space S according to an example of the present disclosure. The air treatment system 100 may be configured as disclosed in FIG. 1a or FIG. 2. In this example, the air treatment system 100 does not comprise any cleaning conduit 7 but instead comprises at least one circulation damper 30 connecting the process air circuit 2 and the regeneration air circuit 4 upstream of the regeneration section 5 of the gas sorption rotor 1. The at least one circulation damper 30 is arranged downstream of the process section 3 of the gas sorption rotor 1.

In this example, outdoor air OA for the cleaning mode is entering the process air circuit 2. To enable the outdoor air OA to circumvent the process section 3 of the gas sorption rotor 1, the air treatment system 100 further comprises a bypass circuit 23 fluidly connected to the process air circuit 2. The bypass circuit 23 is arranged in connection with the process air circuit 2 at a first point upstream of the process section 3 of the gas sorption rotor 1, and at a second point downstream of the process section 3 of the gas sorption rotor 1 and upstream of the at least one circulation damper 30. In order to enable the outdoor air OA to bypass the process section 3 of the gas sorption rotor 1, the air treatment system 100 further comprises a second valve 24 arranged in the bypass circuit 23, and a third valve 25 arranged in the process air circuit 2 upstream of the process section 3 of the gas sorption rotor 1.

The air treatment system 100 comprises a second fan 26 arranged in the process air circuit 2, downstream of the process section 3 of the gas sorption rotor 1. The second fan 26 may be arranged to draw process air through the process section 3 of the gas sorption rotor 1 during normal operation of the air treatment system 100. The process air may also be referred to as outdoor air entering the process air circuit 2.

The control device 6 is arranged in communication with the first and second damper 21, 41, the at least one circulation damper 30, the first fan 8, the second fan 26 and/or the second and third valve 24, 25.

In the cleaning mode, when at least one starting criterion is fulfilled, the control device 6 is configured to control the first fan 8 to draw outdoor air through the process air circuit 2, via the circulation damper 30 to the regeneration air circuit 4 and through the regeneration section 5 of the gas sorption rotor 1. The control device 6 is also configured to control the second valve 24 to open and the third valve 25 to close, to allow outdoor air OA to circumvent the process section 3 of the gas sorption rotor 1 via the bypass conduit 23. The control device 6 is also configured to control the at least one circulation damper 30 to open to allow the outdoor air OA to flow to the regeneration air circuit 4 and through the regeneration section 5 of the gas sorption rotor 1. The control device 6 may further be configured to close the first damper 21 and/or the second damper 42 during the cleaning mode.

The figure shows the air treatment system 100 in the cleaning mode, where outdoor air OA is entering the process air circuit 2, bypassing (circumventing) the process section 3 of the gas sorption rotor 1 via the bypass circuit 23, passing via the at least one circulation damper 30 to the regeneration air circuit 4, and through the regeneration section 5 of the gas sorption rotor 1 before being exhausted. The flow of the outdoor air OA is illustrated with arrows in the figure.

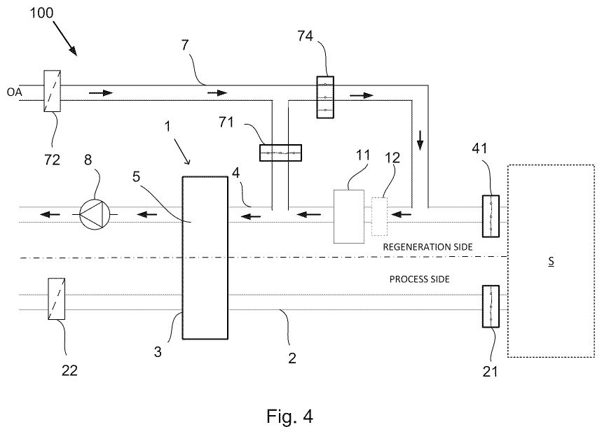

FIG. 4 schematically illustrates an air treatment system 100 for providing treated air in a defined space S according to an example of the present disclosure. The air treatment system 100 may be configured as disclosed in FIG. 1a, 2 or 3. In this example, the air treatment system 100 comprises an evaporative humidifier 11 arranged in the regeneration air circuit 4. The evaporative humidifier 11 is arranged upstream of the regeneration section 5 of the gas sorption rotor 1. The evaporative humidifier 11 may be used for regeneration during normal operation of the air treatment system 100 but may also be used in the cleaning mode. The control device 6 may thus be configured to control the flow of outdoor air OA to pass via the evaporative humidifier 11 before passing through the regeneration section 5 of the gas sorption rotor 1.

In this example, the air treatment system 100 comprises the cleaning conduit 7 for use during the cleaning mode. The cleaning conduit 7 is thus connected to the regeneration air circuit 4 upstream of the evaporative humidifier 11, such that the outdoor air OA entering the cleaning conduit 7 can be lead through the evaporative humidifier 11 before being passed through the regeneration section 5 of the gas sorption rotor 1. As an example, the cleaning conduit 7 can also be connected to the regeneration air circuit 4 downstream of the evaporative humidifier 11 to enable the outdoor air OA to not pass through the evaporative humidifier 11. In this case, the air treatment system 10 will comprise the first valve 71 arranged in the cleaning conduit 7 as well as a fourth valve 74 arranged in the cleaning conduit 7. When the first valve 71 is open, outdoor air OA will enter the regeneration air circuit 4 downstream of the evaporative humidifier 11. When the fourth valve 74 is open, the outdoor air OA will enter the regeneration air circuit 4 upstream of the evaporative humidifier 11. By controlling the first valve 71 and the fourth valve 74, the outdoor air OA can be controlled to flow through the evaporative humidifier 11 or not.

The air treatment system 100 may optionally comprise a heater device 12 arranged upstream of the evaporative humidifier 11. The cleaning conduit 7 may thus be connected to the regeneration air circuit 4 upstream of the heater device 12. The control device 6 may be configured to control the flow of outdoor air OA to pass via the heater device 12 before passing through the regeneration section 5 of the gas sorption rotor 1.

The control device 6 is thus configured to control the first fan 8 to draw outdoor air OA into the cleaning conduit 7 and through the rest of the air treatment system 100. The control device 6 is also configured to control the first valve 71 and the fourth valve 74 to control the flow of outdoor air OA from the cleaning conduit 7 to the regeneration air circuit 4.

The figure shows the air treatment system 100 in the cleaning mode, where outdoor air OA is entering the cleaning conduit 7, the first valve 71 is closed and the fourth valve 74 is open, such that the outdoor air OA is entering the regeneration air circuit 4 upstream of the evaporative humidifier 11. The outdoor air OA passes through the evaporative humidifier 11 before passing through the regeneration section 5 of the gas sorption rotor 1. The flow of outdoor air OA is illustrated with arrows in the figure.

The control device 6 may be configured to periodically control the flow of outdoor air OA to pass via the evaporative humidifier 11 during cleaning mode or the control device 6 may be configured to control the flow of outdoor air OA to pass via the evaporative humidifier 11 during cleaning mode, based on the humidity or temperature of the incoming outdoor air OA, or the current VOC/odor level in the defined space S.

It is to be understood that even if it is not shown in the figure, the air treatment system 100 may comprise the bypass circuit 23 and the second fan 26 etc. as shown in FIG. 3.

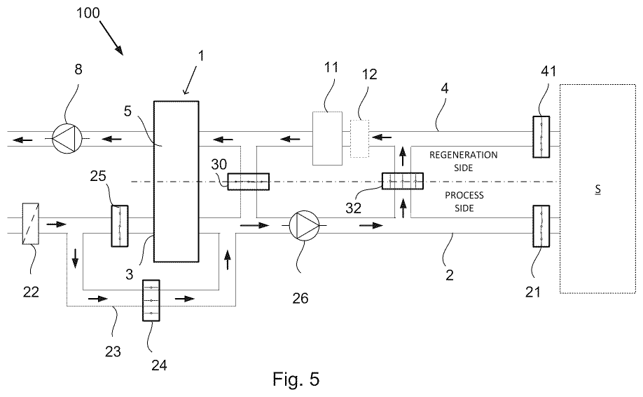

FIG. 5 schematically illustrates an air treatment system 100 for providing treated air in a defined space S according to an example of the present disclosure. The air treatment system 100 may be configured as disclosed in FIG. 1a, 2, 3 or 4. In this example, the air treatment system 100 comprises an evaporative humidifier 11 arranged in the regeneration air circuit 4. The evaporative humidifier 11 is arranged upstream of the regeneration section 5 of the gas sorption rotor 1. The evaporative humidifier 11 may be used for regeneration during normal operation of the air treatment system 100 but may also be used in the cleaning mode. The control device 6 may thus be configured to control the flow of outdoor air OA to pass via the evaporative humidifier 11 before passing through the regeneration section 5 of the gas sorption rotor 1.

In this example, the air treatment system 100 is configured to use outdoor air OA entering the process air circuit 2 during the cleaning mode. The air treatment system 100 comprises at least one circulation damper 32 arranged to connect the process air circuit 2 with the regeneration air circuit 4 upstream of the evaporative humidifier 11. Typically, the air treatment system 100 comprises a first circulation damper 30 connecting the process air circuit 2 with the regeneration air circuit 4 downstream of the evaporative humidifier 11 and a second circulation damper 32 connecting the process air circuit 2 with the regeneration air circuit 4 upstream of the evaporative humidifier 11. By controlling the first circulation damper 30 and the second circulation damper 32, the outdoor air OA can be controlled to pass through the evaporative humidifier 11 or not.

The air treatment system 100 may optionally comprise a heater device 12 arranged upstream of the evaporative humidifier 11. The second circulation damper 32 may thus be arranged to connect the process air circuit 2 and the regeneration air circuit 4 upstream of the heater device 12. The control device 6 may be configured to control the flow of outdoor air OA to pass via the heater device 12 before passing through the regeneration section 5 of the gas sorption rotor 1.

In the cleaning mode, the control device 6 is configured to control the first fan 8 to draw outdoor air OA into the process air circuit 2 and through the rest of the air treatment system 100. The control device 6 is also configured to control the second valve 24 to open and the third valve 25 to close, to allow outdoor air OA to circumvent the process section 3 of the gas sorption rotor 1 via the bypass conduit 23. The control device 6 is further configured to control the first circulation damper 30 and the second circulation damper 32 to control the flow of outdoor air OA from the process air circuit 2 to the regeneration air circuit 4. The control device 6 may further be configured to close the first damper 21 and/or the second damper 42 during the cleaning mode.

The figure shows the air treatment system 100 in the cleaning mode, where outdoor air OA is entering the process air circuit 2, the third valve 25 is closed and the second valve 24 is open to bypass the process section 3 of the gas sorption rotor 1. The first circulation damper 30 is closed and the second circulation damper 32 is open, such that the outdoor air OA is entering the regeneration air circuit 4 upstream of the evaporative humidifier 11. The outdoor air OA thus passes through the evaporative humidifier 11 before cleaning the regeneration section 5 of the gas sorption rotor 1. The flow of outdoor air OA is illustrated with arrows in the figure.

The control device 6 may be configured to periodically control the flow of outdoor air OA to pass via the evaporative humidifier 11 during cleaning mode or the control device 6 may be configured to control the flow of outdoor air OA to pass via the evaporative humidifier 11 during cleaning mode, based on the humidity or temperature of the incoming outdoor air OA, or the current VOC/odor level in the defined space S.

FIG. 6 shows a diagram of a method for controlling an air treatment system 100 according to an example of the present disclosure, The air treatment system 100 may be configured as disclosed in FIG. 1a, 3, 4 or 5. The method comprises the step of determining s101 that at least one predetermined starting criterion is fulfilled; and controlling s102, in a cleaning mode, a flow of outdoor air OA to circumvent the process section 3 of the gas sorption rotor 1 and pass through the regeneration section 5 of the gas sorption rotor 1 before being exhausted. The method is preferably a computer-implemented method performed by means of the control device 6 described herein.

The at least one starting criterion may comprise that the humidity of the outdoor air OA is above a predefined lower threshold level. The predefined lower threshold level may be 40%, preferably 50% or more preferably 60%. The at least one starting criterion may alternatively or additionally comprise that the outdoor air OA has a temperature within a predefined temperature range. The predefined temperature range may be between 5-18 degrees Celsius. Alternatively or additionally, the at least one starting criterion comprises that a measured VOC (Volatile Organic Compound) level in the defined space S is above a predetermined VOC level and/or that a measured odor level in the defined space S is above a predetermined odor level. The at least one starting criterion may comprise a predetermined time parameter, such that the cleaning mode is initiated at a predetermined time of the day or and/or day of the week and/or month of the year. The time parameter may comprise that the cleaning mode should be Initiated after office hours. Alternatively, the time parameter comprises that the cleaning mode should be initiated during the night after normal operation of the air treatment system 100, or early in the morning just before normal operation of the air treatment system 100. The time parameter may comprise that the cleaning mode should be performed only at certain days of the week, once a week, once a month, only during summer months or similar. According to another example, the at least one starting criterion comprises manual input requesting cleaning mode.

It is to be understood that any combination of starting criteria mentioned herein is possible. This does not mean that all criteria must be fulfilled at the same time, but that at least one of the criteria must be fulfilled in order for the control device to start the cleaning mode.

The step of controlling s102 the flow of outdoor air OA to pass through the regeneration section 5 of the gas sorption rotor 1 may comprise controlling a first fan 8 in the regeneration air circuit 4 to draw outdoor air OA into the air treatment system 100 for the cleaning mode.

The step of controlling s102 the flow of outdoor air OA to pass through the regeneration section 5 of the gas sorption rotor 1 may comprise controlling a first damper 21 to close the communication between the air process circuit 2 and the defined space S. It may also comprise controlling a second damper 41 to close the communication between the regeneration air circuit 4 and the defined space S.

The step of controlling s102 the flow of outdoor air OA to pass through the regeneration section 5 of the gas sorption rotor 1 may comprise controlling the flow of outdoor air OA to enter via a cleaning conduit 7 fluidly connected to the outdoor air OA and the regeneration air circuit 4 upstream of the gas sorption rotor 1. Controlling the flow of outdoor air OA to enter via the cleaning conduit 7 may comprise controlling a first valve 71 to open the communication between the cleaning conduit 7 and the regeneration air circuit 4.

The step of controlling s102 the flow of outdoor air OA to pass through the regeneration section 5 of the gas sorption rotor 1 may alternatively comprise controlling the flow of outdoor air OA to pass from the process air circuit 2 via a circulation damper 30, 32 to the regeneration air circuit 4. The outdoor air OA thus enters via the process air circuit 2, passes via the circulation damper 30, 32 to the regeneration air circuit 4 and then passes through the regeneration section 5 of the gas sorption rotor 1. This may comprise controlling at least one circulation damper 30, 32 to open the communication between the process air circuit 2 and the regeneration air circuit 4. It may also comprise controlling a second valve 24 in a bypass circuit 23 to open to enable the outdoor air OA to circumvent the process section 3 of the gas sorption rotor 1.

The method may further comprise the step of controlling s103 the flow of outdoor air OA to pass via an evaporative humidifier 11 arranged in the regeneration air circuit 4, before passing through the regeneration section 5 of the gas sorption rotor 1. In the event that the air treatment system 100 comprises the cleaning conduit 7, this may comprise controlling the first valve 71 to close and a fourth valve 74 in the cleaning conduit 7 to open, to make the outdoor air OA enter the regeneration air circuit 4 upstream of the evaporative humidifier 11. In the event that the outdoor air OA for the cleaning mode enters the process air circuit 2, the method step may comprise controlling a first circulation damper 30 to close, and a second circulation damper to open to make the outdoor air OA enter the regeneration air circuit 4 upstream of the evaporative humidifier 11.

The method may further comprise the step of controlling s104 the flow of outdoor air OA to pass via a heater device 12 arranged in the regeneration air circuit 4, before passing through the regeneration section 5 of the gas sorption rotor 1.

The method may further comprise the step of terminating s105 the cleaning mode when the at least one predetermined termination criterion is fulfilled, wherein the at least one predetermined termination criterion comprises that a predetermined time has lapsed after initiation of the cleaning mode and/or that the VOC level of the air downstream of the regeneration section 5 of the gas sorption rotor 1 is below a predetermined termination VOC level.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1.-15. (canceled)

16. An air treatment system for providing treated air in a defined space, the air treatment system comprising:
a gas sorption device with a gas sorption rotor;
a process air circuit arranged to conduct a process air flow through a process section of the gas sorption rotor;
a regeneration air circuit arranged to conduct a regeneration air flow through a regeneration section of the gas sorption rotor; and
a control device configured to determine that at least one predetermined starting criterion is fulfilled, and to control, in a cleaning mode, a flow of outdoor air to circumvent the process section of the gas sorption rotor, and pass through the regeneration section of the gas sorption rotor before being exhausted,
wherein the at least one starting criterion concerns at least one attribute of the outdoor air, or at least one attribute of the air in the defined space.

17. The air treatment system according to claim 16, wherein the at least one starting criterion comprises that the humidity of the outdoor air is above a predefined lower threshold level.

18. The air treatment system according to claim 16, wherein the at least one starting criterion comprises that the outdoor air has a temperature within a predefined temperature range.

19. The air treatment system according to claim 16, wherein the at least one starting criterion comprises that a measured VOC level in the defined space is above a predetermined VOC level.

20. The air treatment system according to claim 16, wherein the at least one starting criterion further comprises a predetermined time parameter, such that the cleaning mode is initiated at a predetermined time of the day, day of the week, and/or month of the year.

21. The air treatment system according to claim 16, further comprising:
a cleaning conduit fluidly connected to the outdoor air and the regeneration air circuit upstream of the gas sorption rotor,
wherein the control device is configured to control the flow of outdoor air to enter via the cleaning conduit.

22. The air treatment system according to claim 16, further comprising:
at least one circulation damper connecting the process air circuit and the regeneration air circuit upstream of the gas sorption rotor,
wherein the control device is configured to control the flow of outdoor air to pass from the process air circuit via the circulation damper to the regeneration air circuit.

23. The air treatment system according to claim 16, further comprising:
an evaporative humidifier arranged in the regeneration air circuit,
wherein the control device is configured to control the flow of outdoor air to pass via the evaporative humidifier before passing through the regeneration section of the gas sorption rotor.

24. The air treatment system according to claim 16, further comprising:
a heater device arranged in the regeneration air circuit,
wherein the control device is configured to control the flow of outdoor air to pass via the heater device before passing through the regeneration section of the gas sorption rotor.

25. The air treatment system according to claim 16, wherein the control device is configured to terminate the cleaning mode when at least one predetermined termination criterion is fulfilled, wherein the at least one predetermined termination criterion comprises that a predetermined time has lapsed after initiation of the cleaning mode and/or that the VOC level of the air downstream of the regeneration section of the gas sorption rotor is below a predetermined termination VOC level.

26. A method for controlling an air treatment system according to claim 16, wherein the method comprises:
determining that the at least one predetermined starting criterion is fulfilled; and
controlling, in the cleaning mode, a flow of the outdoor air to circumvent the process section of the gas sorption rotor and pass through the regeneration section of the gas sorption rotor before being exhausted.

27. The method according to claim 26, wherein the step of controlling the flow of outdoor air to pass through the regeneration section of the gas sorption rotor comprises controlling the flow of outdoor air to enter via a cleaning conduit fluidly connected to the outdoor air and the regeneration air circuit upstream of the gas sorption rotor.

28. The method according to claim 26, wherein the step of controlling the flow of outdoor air to pass through the regeneration section of the gas sorption rotor comprises controlling the flow of outdoor air to pass from the process air circuit via a circulation damper to the regeneration air circuit.

29. The method according to claim 26, wherein the method further comprises:
controlling the flow of outdoor air to pass via an evaporative humidifier in the regeneration air circuit before passing through the regeneration section of the gas sorption rotor.

30. A computer program for an air treatment system comprising a gas sorption device with a gas sorption rotor; a process air circuit arranged to conduct a process air flow through a process section of the gas sorption rotor; a regeneration air circuit arranged to conduct a regeneration air flow through a regeneration section of the gas sorption rotor; and a control device comprising at least one processor, the computer program comprising computer-readable instructions which, when executed by the at least one processor, causes the air treatment system to carry out the steps of the method of claim 26.
